(19) United States
(12) Patent Application Publication
(10) Pub. No.: US 2023/0211842 A1
(43) Pub. Date: Jul. 6, 2023

(54) AUTONOMOUS WALKING VEHICLE

(71) Applicants: Hyundai Motor Company, Seoul (KR); Kia Corporation, Seoul (KR)

(72) Inventors: Ernestine Fu, Superior Township, MI (US); Piotr Swierczynski, Superior Township, MI (US); John Suh, Palo Alto, CA (US); Daniel Chan, Superior Township, MI (US); Leaf Jiang, Superior Township, MI (US); Brad Rosen, Superior Township, MI (US)

(21) Appl. No.: 17/567,031

(22) Filed: Dec. 31, 2021

(51) Int. Cl. B62D 57/028; H04N 5/247; G06V 20/56; H04N 13/282; H04N 13/243; B60W 60/00; G05D 1/02

(52) U.S. Cl. CPC B62D 57/028; H04N 5/247; G06V 20/56; H04N 13/282; H04N 13/243; B60W 60/001; G05D 1/0231; B60W 2420/42

(57) ABSTRACT

In one aspect, a vehicle is provided that includes i) a plurality of wheel-leg components and ii) a surround view imaging system for generating a surround view image of the vehicle. The plurality of wheel-leg components can operate to provide locomotion to the vehicle. The surround view image comprising a 360-degree, three-dimensional view of an environment surrounding the vehicle. The vehicle is configured to operate autonomously using the surround image view to control the locomotion of the plurality of the wheel-leg components.

### BACKGROUND

Vehicles have been proposed that are capable of navigating difficult terrain and environments. These vehicle do not exclusively use wheels to navigate, but rather are equipped with legs that allow the vehicle to step or walk through difficult terrain. For example, such a vehicle is capable of navigating through a forest by moving around trees, climbing over objects such as downed trees or rocks, traversing creeks and streams, and otherwise traversing the terrain.

Furthermore, some of the proposed vehicles are capable of autonomous movement, such that the vehicles can navigate the terrain towards a destination without an active user or driver present. In order to navigate autonomously, these vehicle require a knowledge of the space within which they are navigating, understanding objects and obstacles to travel over or around.

### SUMMARY

In one aspect, we now provide imaging systems of a vehicle's environment, including long-range, high-resolution, three-dimensional, surround view imaging of a vehicle's environment.

In preferred aspects, the surround view can enable or facilitate autonomous navigation of the vehicle through the environment by identifying obstacles, paths, etc. The present systems can provide locally processed, real-time detection of objects in a high-vibration environment. In particular, embodiments described herein can provide a three-dimensional vision system for an omnidirectional vehicle, which requires a 360-degree surround view for autonomous navigation.

In a preferred aspect, vehicles are provided that comprise a) a plurality of wheel-leg components, wherein the plurality of wheel-leg components can operate to provide locomotion to the vehicle; and b) an imaging system for generating a surround view image of the vehicle. Preferably, the imaging system can generate a view image of the vehicle, the surround view image comprising a 360-degree, three-dimensional view of an environment surrounding the vehicle. Preferably, the vehicle is configured to operate autonomously based on data from the imaging system. The imaging system comprises a plurality of cameras. Preferably, a plurality of cameras are positioned on the vehicle to provide a 360-degree view around the vehicle. The vehicle suitably comprises a chassis in communication with the wheel-leg components.

The preferred lightweight construction, multi-jointed wheel-leg components, and active suspension of the preferred omnidirectional walking vehicle described herein present a unique challenge for traditional stereo vision systems, due to constant motion and camera mounting constraints. In one aspect, the present vehicles are capable of locomotion using both, either or alternatively 1) a walking motion and/or 2) rolling traction, i.e. 1) a roll or driving state and/or 2) a step or walk state.

We provide imaging view systems for a vehicle capable of autonomous control and omnidirectional movement, including wheeled locomotion and walking locomotion. In some embodiments, the vehicle includes four wheel-leg components that are each capable of up to six or seven degrees of freedom, for a total of 24 or 28 degrees of freedom for the vehicle. For instance, the wheel-leg components are capable of actively driven wheel locomotion (one degree of freedom) and five degrees of freedom within joints of the leg. Such degrees of freedom also are described in U.S. Patent Application Publication 2020/0216127. The wheel-leg components are configured to operative cooperatively to provide different walking gaits that are appropriate to a given terrain.

In order to autonomously navigate, a detailed and accurate understanding of the vehicle surroundings is obtained, using the surround view imaging. This allows the vehicle to select a navigable path through its environment. Furthermore, this allows the vehicle to select the appropriate walking gait through the environment for navigating the selected path. The surround view imaging can be updated as the vehicle travels through its surroundings (e.g., changes its position relative to the surroundings). It should be appreciated that the selected path (e.g., direction of locomotion) may be updated at least as frequently as the surround view imaging is updated. As discussed, in certain aspects, the present vehicles may be autonomous or semi-autonomous. An autonomous vehicle is a vehicle having an autonomous driving function that autonomously controls a vehicle's behavior by identifying and determining surrounding conditions. To achieve a high level of autonomous driving function, an autonomous vehicle needs to safely control its behavior by realizing surrounding environments under various conditions in research and development stages, and by detecting and determining the surrounding environments well.

In a fully autonomous vehicle, the vehicle may perform all driving tasks under all conditions and little or no driving assistance is required a human driver. In semi-autonomous (or partially autonomous) vehicle, for example, the automated driving system may perform some or all parts of the driving task in some conditions, but a human driver regains control under some conditions, or in other semi-autonomous systems, the vehicle's automated system may oversee steering and accelerating and braking in some conditions, although the human driver is required to continue paying attention to the driving environment throughout the journey, while also performing the remainder of the necessary tasks.

Methods are also provided, including methods for operating a method. Preferred methods may include (a) providing a vehicle that comprises i) plurality of wheel-leg components coupled to the chassis, wherein the plurality of wheel-leg components can provide wheeled locomotion and walking locomotion; and ii) an imaging system for generating a view image of the vehicle; and (b) operating the vehicle. In preferred aspects, the imaging system can generate a view image of the vehicle, the surround view image comprising a 360-degree, three-dimensional view of an environment surrounding the vehicle. Preferably, the imaging system comprises a plurality of cameras, suitably positioned at varying locations on the vehicle to enable a 360-degree image of the vehicle's environment. In preferred aspects, the vehicle may be operated autonomously, for example operated partially autonomously or operated fully autonomously. Suitably, in such methods the vehicle further comprises a chassis in communication with the wheel-leg components.

Other aspects of the invention are disclosed infra.

### BRIEF DESCRIPTION OF THE DRAWINGS

The accompanying drawings, which are incorporated in and form a part of the Description of Embodiments, illustrate various embodiments of the subject matter and, together with the Description of Embodiments, serve to explain principles of the subject matter discussed below. Unless specifically noted, the drawings referred to in this Brief Description of Drawings should be understood as not being drawn to scale. Herein, like items are labeled with like item numbers.

FIG. 1A depicts a vehicle capable of locomotion using both walking motion and rolling motion, according to embodiments.

FIGS. 1B through 1D illustrate perspective views of different walking gaits, according to embodiments.

FIG. 2 is a diagram illustrating an example quad stereo camera system of a vehicle capable of autonomous locomotion using both walking motion and rolling motion, according to embodiments.

FIG. 3 illustrates an example still image from a stereo camera on a vehicle capable of autonomous locomotion using both walking motion and rolling motion, according to an embodiment.

FIG. 4 illustrates an example depth map from a still image captured from stereo camera on a vehicle capable of autonomous locomotion using both walking motion and rolling motion, according to an embodiment.

FIG. 5 illustrates a diagram of a vehicle utilizing a multi-stereo camera system for generating a surround view image for use in autonomous navigation, according to embodiments.

FIG. 6 is a block diagram of an example system for generating a surround view image for use in autonomous navigation, according to embodiments.

FIG. 7 illustrates an example computer system upon which embodiments described herein be implemented.

### DETAILED DESCRIPTION

The following Description of Embodiments is merely provided by way of example and not of limitation. Furthermore, there is no intention to be bound by any expressed or implied theory presented in the preceding background or in the following Description of Embodiments.

Reference will now be made in detail to various embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications and equivalents, which may be included within the spirit and scope the various embodiments as defined by the appended claims. Furthermore, in this Description of Embodiments, numerous specific details are set forth in order to provide a thorough understanding of embodiments of the present subject matter. However, embodiments may be practiced without these specific details. In other instances, well known methods, procedures, and components have not been described in detail as not to unnecessarily obscure aspects of the described embodiments.

Some portions of the detailed descriptions which follow are presented in terms of procedures, logic blocks, processing and other symbolic representations of operations on data within an electrical circuit. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities take the form of electrical or magnetic signals capable of being stored, transferred, combined, compared, and otherwise manipulated in an electronic device.

It should be borne in mind, however, that all of these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “generating,” “determining,” “simulating,” “transmitting,” “iterating,” “comparing,” “maintaining,” “calculating,” or the like, refer to the actions and processes of an electronic device such as: a processor, a memory, a computing system, a mobile electronic device, or the like, or a combination thereof. The electronic device manipulates and transforms data represented as physical (electronic and/or magnetic) quantities within the electronic device's registers and memories into other data similarly represented as physical quantities within the electronic device's memories or registers or other such information storage, transmission, processing, or display components.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example fingerprint sensing system and/or mobile electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration.

Discussion begins with a description of a vehicle capable of autonomous navigation using both wheeled locomotion and walking locomotion, in accordance with various embodiments. An example system for generating a surround view image for use in such a vehicle is then described.

Embodiments described herein provide a walking vehicle including a chassis and a plurality of wheel-leg components. The plurality of wheel-leg components are collectively operable to provide wheeled locomotion and walking locomotion. In some embodiments, the wheel-leg components have multiple degrees of freedom. In some embodiments, the wheel-leg components provide the wheeled locomotion in a retracted position and provide the walking locomotion in an extended position. In one embodiment, the plurality of wheel-leg components utilize a mammalian walking gait during the walking locomotion. In one embodiment, the plurality of wheel-leg components utilize a reptilian walking gait during the walking locomotion.

In preferred aspects, vehicles and wheel-leg components as disclosed in U.S. Patent Publication 2020/0216127 may be utilized.

Embodiments described here provide a long-range, high-resolution, three-dimensional, surround view imaging of a vehicle's environment. The surround view enables autonomous navigation of the vehicle through the environment by identifying obstacles, paths, etc. Embodiments described herein provide a three-dimensional vision system for an omnidirectional vehicle, which requires a 360-degree surround view for autonomous navigation. In order to autonomously navigate, a detailed and accurate understanding of the vehicle surroundings is obtained, using the surround view imaging. This allows the vehicle to select a navigable path through its environment. Furthermore, this allows the vehicle to select the appropriate walking gait through the environment for navigating the selected path. The surround view imaging can be updated as the vehicle travels through its surroundings (e.g., changes its position relative to the surroundings). It should be appreciated that the selected path (e.g., direction of locomotion) may be updated at least as frequently as the surround view imaging is updated.

### A Surround View Image System for a Walking Vehicle

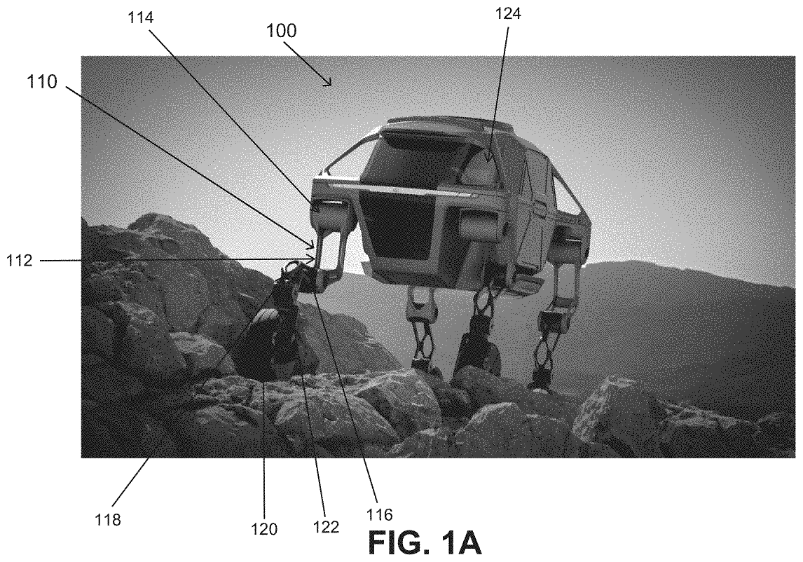

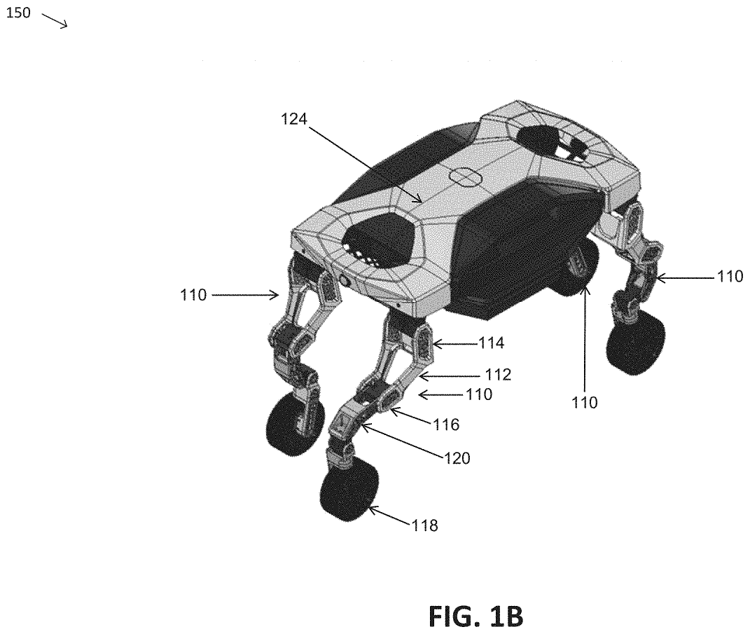

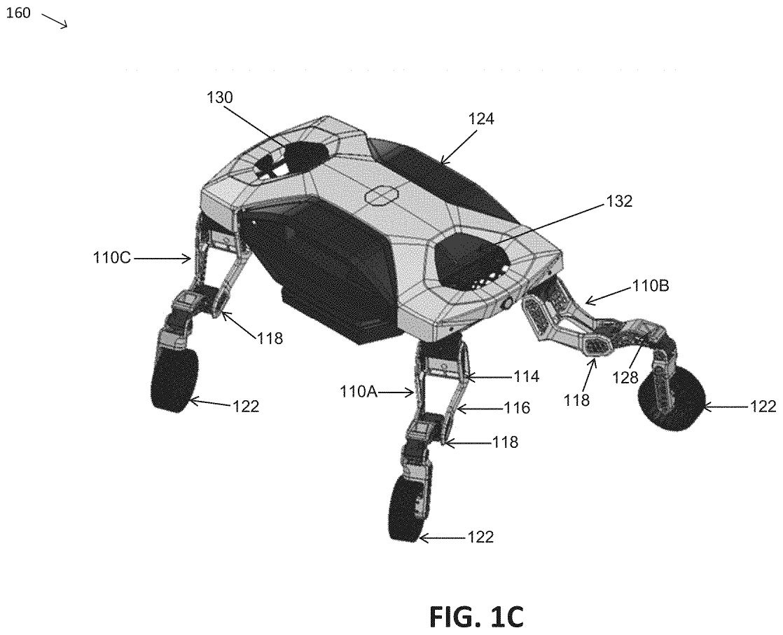

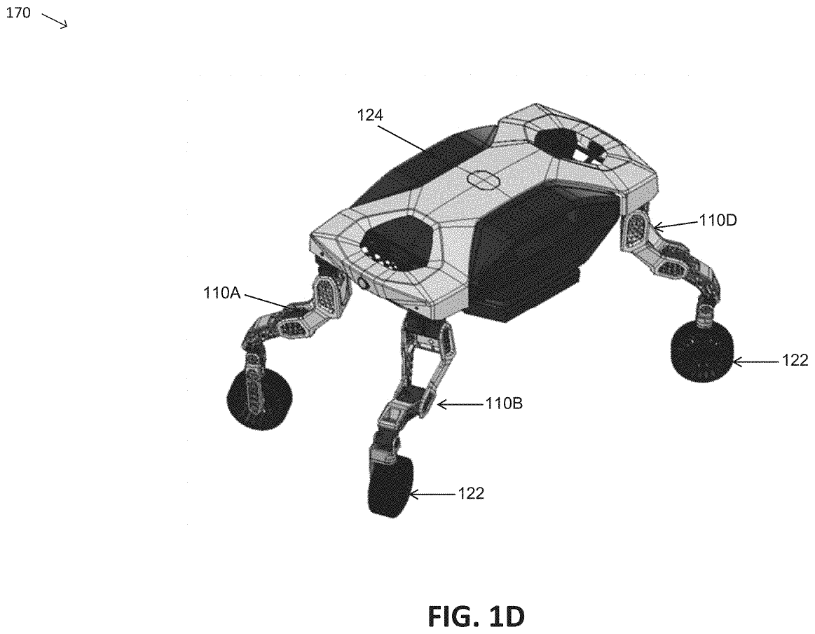

FIG. 1A is a diagram illustrating an example vehicle 100 capable of locomotion using both walking motion and rolling motion, according to embodiments. Vehicle 100 includes four wheel-leg components 110, where wheel-leg components 110 include at least two degrees of freedom. As shown in FIGS. 1A, 1B and 1C, the depicted wheel-leg components 110 include upper leg portion 112 that mates with hip portion 114 and knee portion 116. Lower leg portion 118 mates with knee potion 116 and ankle portion 122 which communicates with wheel 120. As shown, vehicle 100 includes a passenger compartment 124 capable of holding people and may including coupling areas 130 and 132. It should be appreciated that vehicle 100, in some embodiments, may not include a passenger compartment. For instance, vehicle 100 can be of a size that is too small for holding passengers, and/or may be configured for cargo transport or terrain exploration under unmanned control.

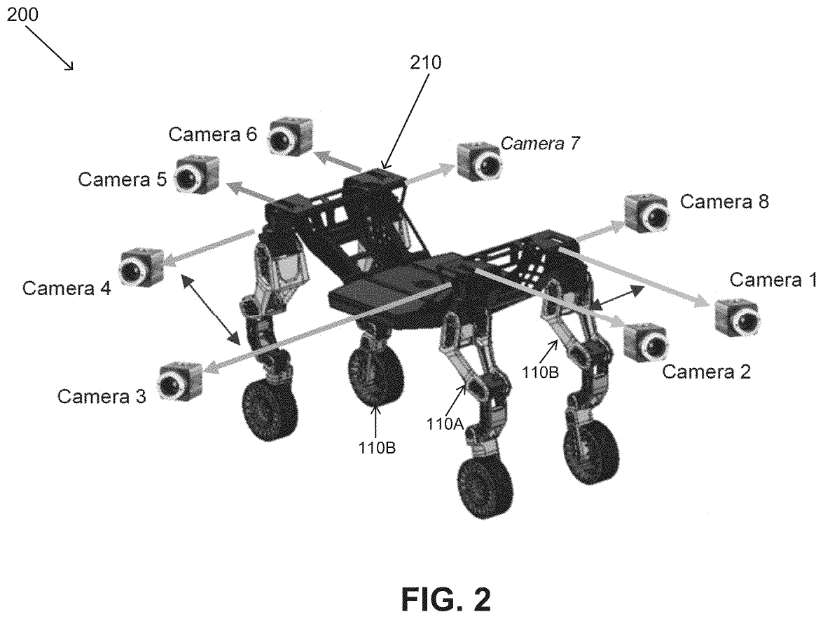

Multiple (such as four per vehicle) wheel-leg components are preferably used with a vehicle. FIGS. 1C, 1D and 2 each depicts multiple wheel-leg components 110A, 110B, 110C and 110D. FIG. 1C also depicts wheel bottom surface 122 that contacts with the ground surface.

In one embodiment, wheel-leg components 110 include six degrees of freedom. It should be appreciated that while wheel-leg components 110 are controlled collectively to provide rolling and walking locomotion, each wheel-leg component 110 is capable of different movement or positioning during operation. For example, while using wheeled locomotion on an upward slope, in order to maintain the body of vehicle 100 level with flat ground, the front wheel-leg components 110 may be retracted and the rear wheel-leg components 110 be extended. In another example, while using walking locomotion to traverse rough terrain, each wheel-leg component 110, or opposite pairs of wheel-leg components 110 (e.g., front left and rear right), can move differently than the other wheel-leg components 110.

In some embodiments, vehicle 100 includes four wheel-leg components 110 that are each capable of up to six degrees of freedom, for a total of twenty-four degrees of freedom for the vehicle. For instance, the wheel-leg components are capable of actively driven wheel locomotion (one degree of freedom) and five degrees of freedom within joints of the leg. The wheel-leg components 110 are configured to operative cooperatively to provide different walking gaits that are appropriate to a given terrain.

Embodiments of the described vehicle are serviceable in different use cases, such as use in extreme environments. As illustrated, vehicle 100 is shown in a mountainous region with uneven and rocky terrain, requiring the usage of walking locomotion. The described vehicle may be of a size to hold and transport passengers, or may be a smaller unmanned vehicle meant for exploration or cargo transport. Depending on the use case, there are mobility capabilities that cover most types of terrain traversal while in walking locomotion mode. The mobility capabilities include, without limitation, 1) step-up, 2) ramp or incline climb, 3) obstacle step-over, and 4) gap crossing.

In some embodiments, vehicle 100 can operate in different walking locomotion modes, such as a mammalian walking gait or a reptilian walking gate. As with the mammalian and reptilian walking gaits found naturally in mammals and reptiles, different walking gaits are amenable to different terrains and environments. For instance, a reptilian gait has a wide stance, increasing balance, while a mammalian gait generally improves traversal in the forward direction by providing increased speed. Other walking gaits, or combinations of features from different walking gaits found in nature, can be combined to provide desired mobility and locomotion. For example, vehicle 100 may require the ability to fold wheel-leg components 110 so that they would be compact when retracted.

Vehicle 100 includes a system for generating a surround view image of vehicle 100's environment. The surround view enables autonomous navigation of vehicle 100 through the environment by identifying obstacles, paths, etc. The surround view image generation system provides locally processed, real-time detection of objects in a high-vibration environment. Embodiments described herein provide a three-dimensional vision system for vehicle 100, which requires a 360-degree surround view for autonomous and omnidirectional navigation.

FIGS. 1B through 1D illustrate perspective views of different walking gaits of vehicle 100, according to embodiments. FIG. 1B illustrate example perspective view 150 of a vehicle operating in a mammalian walking gait, according to embodiments. The mammalian walking gait positions the legs and support position below the hips, allowing more of the reaction force to translate axially through each link rather than in shear load. In this position each leg is closer to a singularity, meaning that for a given change in a joint angle, the end effector will move relatively little. This results in a relatively energy efficient gait which is well suited for moderate terrain over longer periods of time, but may not be as stable because of the more narrow stance of the vehicle.

FIG. 1C illustrate example perspective view 160 of a vehicle operating in a reptilian walking gait, according to embodiments. The reptilian walking gait mirrors how animals such as a lizard or gecko might traverse terrain. In this position, the gait relies more heavily on the hip abduction motors which swing the legs around the vertical axis, maintaining a wider stance. This gait position results in a higher level of stability and control over movement, but is less energy efficient. The wide stance results in high static loads on each motor, making the reptilian gait best suited for walking across extremely unpredictable, rugged terrain for short periods of time.

FIG. 1D illustrate example perspective view 170 of a vehicle operating in a hybrid walking gait, according to embodiments. In addition to reptilian and mammalian gaits, a variety of variants combining the strategies are possible. These variants can be generated through optimization techniques or discovered through simulation and machine learning. These hybrid gaits allow to optimize around the strengths and weaknesses of the more static bio-inspired gaits, transitioning to a more mammalian-style gait when terrain is gentler and a reptilian-style gait in extremely rugged or dynamic environments. In dynamic and highly variable terrains, vehicle 100 could constantly adjust its gait based on the environment, battery charge, and any number of other factors.

In accordance with various embodiments, the system for generating a surround view image utilizes multiple stereo cameras for image capture. It should be appreciated that any number of stereo cameras may be utilized in generating the surround view image. In one embodiments, for example as illustrated in FIG. 2, four stereo cameras are used.

FIG. 2 is a diagram illustrating an example quad stereo camera system 200 of a vehicle 210 capable of autonomous locomotion using both walking motion and rolling motion, according to embodiments. Quad stereo camera system 200 includes four stereo cameras, where each stereo camera includes a pair of cameras. As illustrated, camera pair 220 includes cameras 1 and 2, camera pair 222 includes cameras 3 and 4, camera pair 224 includes cameras 5 and 6, and camera pair 226 includes cameras 7 and 8. Cameras 1, 3, 5, and 7 are left cameras of the respective camera pairs, and cameras 2, 4, 6, and 8 are right cameras of the respective camera pairs. The images captured in cameras are processed to generate a three-dimensional depth map, also referred to herein as a surround view image, for use in autonomous navigation.

Embodiments described herein utilize a system of stereo cameras to generate a surround view image using location and mapping techniques, as well as the pose of the vehicle itself. It should be appreciated that the pose of the vehicle can be determined either directly (e.g., using motor encoders of the wheel-leg components to determine an absolute pose of the vehicle) or implicitly (e.g., by knowing the position of the vehicle relative to the environment from the surround stereo image). For example, when the vehicle is located in uneven terrain (e.g., where the wheel-leg components are subject to slipping or sinking in soft terrain) it may be difficult to determine the pose of the vehicle. The system described herein is capable of generating a surround stereo image using cameras on all sides of the vehicle. This is useful, for example, where a horizon line moves relative to the vehicle or where rocks move upon contact with the vehicle.

When using walking locomotion to navigate terrain, wheel-leg components of the vehicle are operable to walk or step through the environment, where the wheel-leg components are lifted and placed in different locations to move the vehicle. The surround view image allows for the accurate and appropriate placement of the wheel-leg components. Moreover, using the surround view image, a best route through space to a destination or objective can be determined. This best route can be updated during the movement of the vehicle continuously, allowing for adjustments to the route as new information (e.g., obstacles) is obtained from the surround view image. For example, a large rock may block the view of a downed tree. As the vehicle moves around the large rock, the surround view image identifies the downed tree. The vehicle navigation can update to determine whether the downed tree can be traversed, or whether the vehicle should determine another route of navigation.

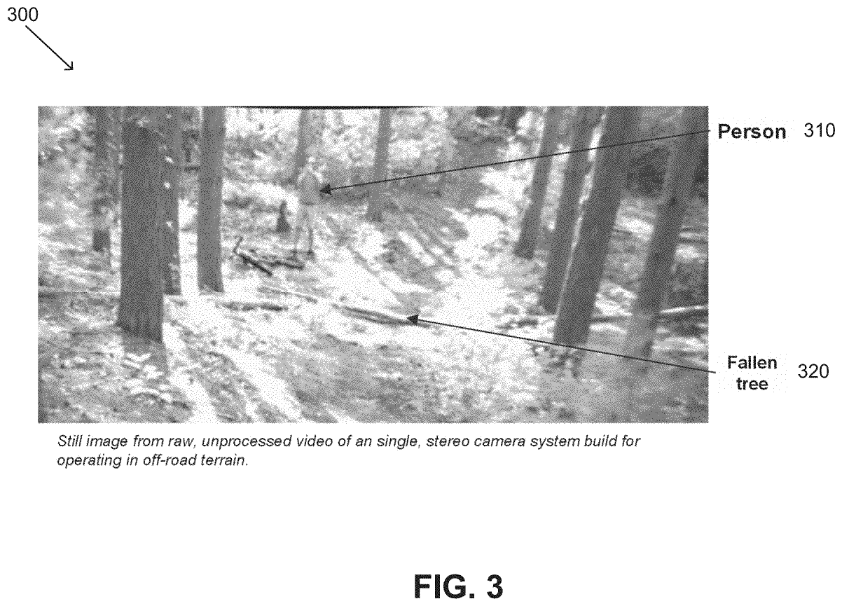

FIG. 3 illustrates an example still image 300 from a stereo camera on a vehicle capable of autonomous locomotion using both walking motion and rolling motion, according to an embodiment. Still image 300 is generated using the two cameras (e.g., a camera pair of FIG. 2) of a stereo camera. As illustrated, still image 300 includes person 310 and fallen tree 320.

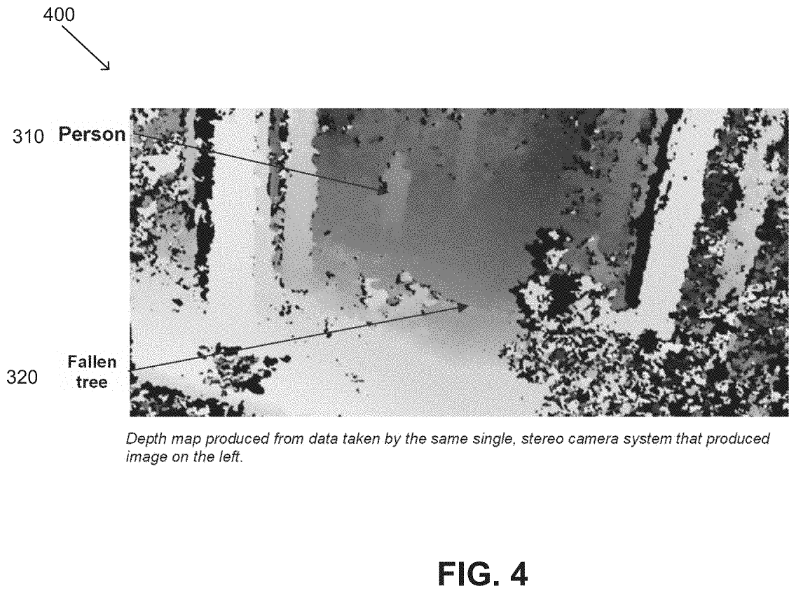

FIG. 4 illustrates an example depth map 400 generated from a still image 300 captured from stereo camera on a vehicle capable of autonomous locomotion using both walking motion and rolling motion, according to an embodiment. Stereo cameras are operable to provide depth information, allowing for depth map 400 to be generated. As illustrated, depth map 400 also includes person 310 and fallen tree 320. Person 310 and fallen tree 320 are now objects in the environment of which the vehicle is aware, allowing for a navigation system of the vehicle to determine a route for navigation.

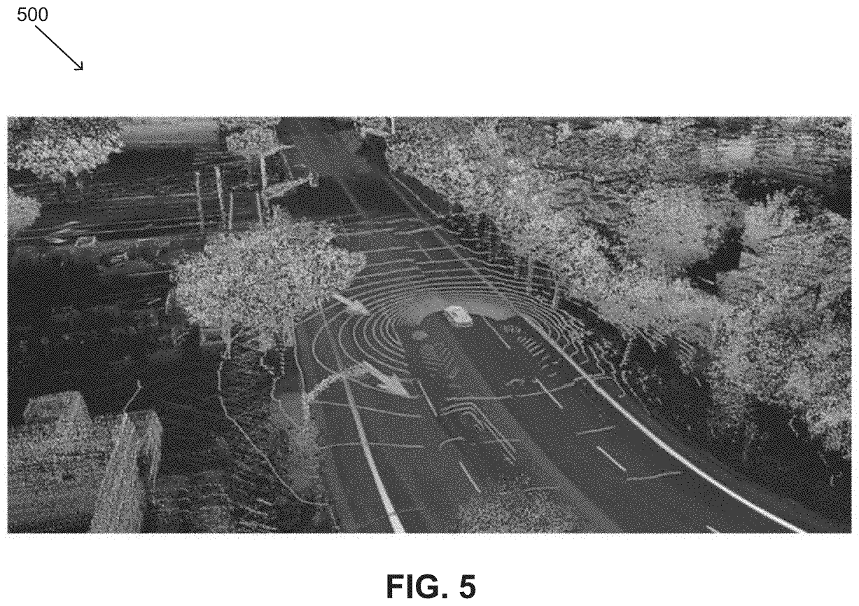

FIG. 5 illustrates a diagram 500 of a vehicle utilizing a multi-stereo camera system for generating a surround view image for use in autonomous navigation, according to embodiments. Diagram 500 illustrates a vehicle driving on a street using wheeled locomotion while generating a surround view image. Using the surround view image, the navigation system of the vehicle can autonomously navigate the vehicle to a destination.

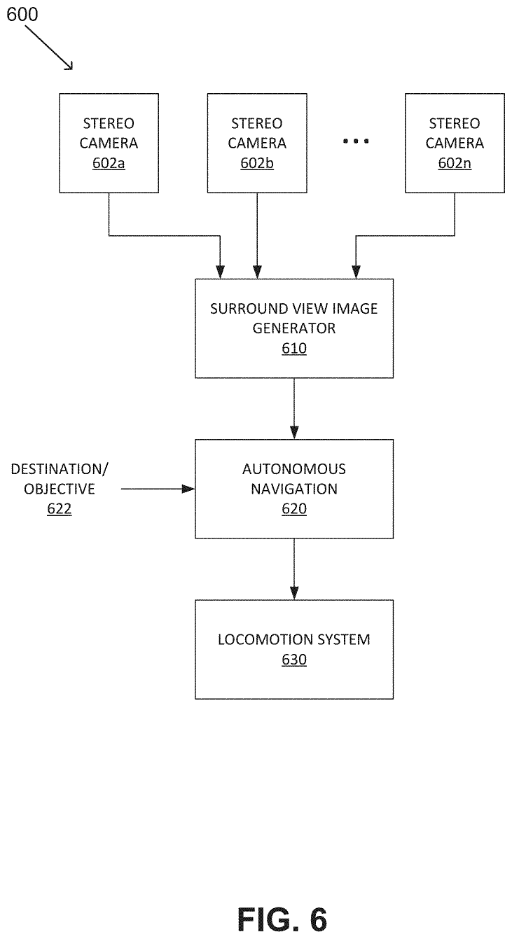

FIG. 6 is a block diagram of an example system 600 for generating a surround view image for use in autonomous navigation, according to embodiments. System 600 includes a plurality of stereo cameras 602a, 602b, and 602n. It should be appreciated that system 600 can include any number of stereo cameras. For example, as illustrated in FIG. 2, system 600 can include four stereo cameras, one located on each side of a four sided vehicle. However, system 600 can include any number of stereo cameras necessary for generating a surround view image.

The images generated from stereo cameras 602a through 602n are received at surround view image generator 610. Surround view image generator 610 generates a surround view image of the vehicle for use in navigation. The surround view image is a 360-degree three-dimensional image of the environment surrounding the vehicle. In some embodiments, the range and resolution of the surround view image are such that the vehicle can determine a navigable path through its environment. For example, the range of the surround view image can be related to the speed of the vehicle. For instance, the range of the surround image view can be shorter for slower speeds. This could reserve additional digital processing for improving or increasing the resolution of the surround view image.

The surround view image is received at autonomous navigation module 620, which uses the surround view image for autonomous navigation to a destination or objective 622. The destination or objective 622 can be submitted by a user or another computer system, and is used for directing the navigation of the vehicle. Using the surround view image, the vehicle can navigate through its environment to the destination or objective 622, aware of the terrain and any obstacles that must be circumnavigated. Autonomous navigation module 620 transmits control instructions to locomotion system 630 for moving the vehicle through the environment.

Locomotion system 630 receives control instructions from autonomous navigation module 620 and uses the control instructions to control the locomotion of the vehicle. In some embodiments, the vehicle includes walking legs or wheel-leg components, and can operate in different walking locomotion modes, such as a mammalian walking gait or a reptilian walking gate. Using the control instructions, locomotion system 630 controls the operation of the walking legs or wheel-leg components to utilize the selected locomotion (e.g., walking gait, wheeled locomotion, pose, etc.) to propel the vehicle through the environment.

### Example Computer System

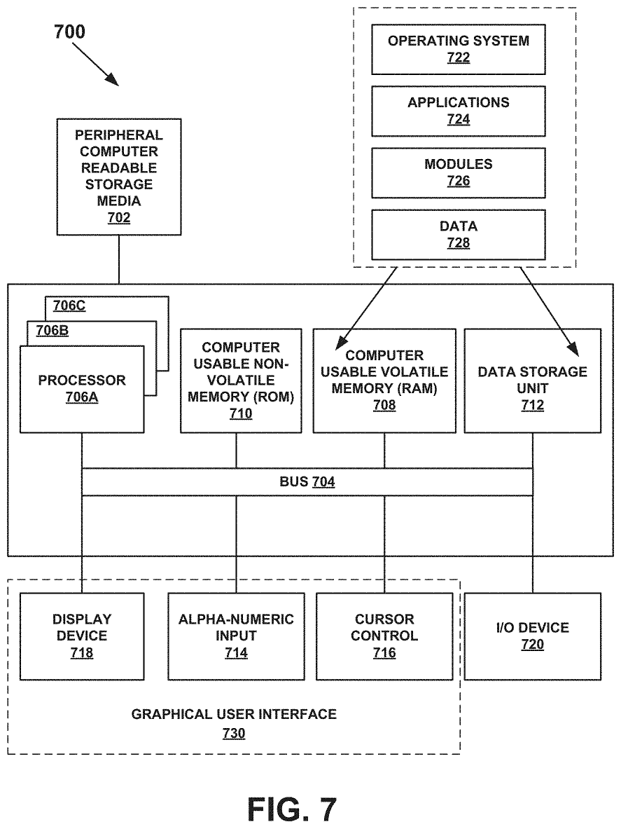

Turning now to the figures, FIG. 7 is a block diagram of an example computer system 700 upon which embodiments of the present invention can be implemented. FIG. 7 illustrates one example of a type of computer system 700 (e.g., a computer system) that can be used in accordance with or to implement various embodiments which are discussed herein.

It is appreciated that computer system 700 of FIG. 7 is only an example and that embodiments as described herein can operate on or within a number of different computer systems including, but not limited to, general purpose networked computer systems, embedded computer systems, mobile electronic devices, smart phones, server devices, client devices, various intermediate devices/nodes, stand alone computer systems, media centers, handheld computer systems, multi-media devices, and the like. In some embodiments, computer system 700 of FIG. 7 is well adapted to having peripheral tangible computer-readable storage media 702 such as, for example, an electronic flash memory data storage device, a floppy disc, a compact disc, digital versatile disc, other disc based storage, universal serial bus “thumb” drive, removable memory card, and the like coupled thereto. The tangible computer-readable storage media is non-transitory in nature.

Computer system 700 of FIG. 7 includes an address/data bus 704 for communicating information, and a processor 706A coupled with bus 704 for processing information and instructions. As depicted in FIG. 7, computer system 700 is also well suited to a multi-processor environment in which a plurality of processors 706A, 706B, and 706C are present. Conversely, computer system 700 is also well suited to having a single processor such as, for example, processor 706A. Processors 706A, 706B, and 706C may be any of various types of microprocessors. Computer system 700 also includes data storage features such as a computer usable volatile memory 708, e.g., random access memory (RAM), coupled with bus 704 for storing information and instructions for processors 706A, 706B, and 706C. Computer system 700 also includes computer usable non-volatile memory 710, e.g., read only memory (ROM), coupled with bus 704 for storing static information and instructions for processors 706A, 706B, and 706C. Also present in computer system 700 is a data storage unit 712 (e.g., a magnetic or optical disc and disc drive) coupled with bus 704 for storing information and instructions. Computer system 700 also includes an alphanumeric input device 714 including alphanumeric and function keys coupled with bus 704 for communicating information and command selections to processor 706A or processors 706A, 706B, and 706C. Computer system 700 also includes an cursor control device 716 coupled with bus 704 for communicating user input information and command selections to processor 706A or processors 706A, 706B, and 706C. In one embodiment, computer system 700 also includes a display device 718 coupled with bus 704 for displaying information.

Referring still to FIG. 7, display device 718 of FIG. 7 may be a liquid crystal device (LCD), light emitting diode display (LED) device, cathode ray tube (CRT), plasma display device, a touch screen device, or other display device suitable for creating graphic images and alphanumeric characters recognizable to a user. Cursor control device 716 allows the computer user to dynamically signal the movement of a visible symbol (cursor) on a display screen of display device 718 and indicate user selections of selectable items displayed on display device 718. Many implementations of cursor control device 716 are known in the art including a trackball, mouse, touch pad, touch screen, joystick or special keys on alphanumeric input device 714 capable of signaling movement of a given direction or manner of displacement. Alternatively, it will be appreciated that a cursor can be directed and/or activated via input from alphanumeric input device 714 using special keys and key sequence commands. Computer system 700 is also well suited to having a cursor directed by other means such as, for example, voice commands. In various embodiments, alphanumeric input device 714, cursor control device 716, and display device 718, or any combination thereof (e.g., user interface selection devices), may collectively operate to provide a graphical user interface (GUI) 730 under the direction of a processor (e.g., processor 706A or processors 706A, 706B, and 706C). GUI 730 allows user to interact with computer system 700 through graphical representations presented on display device 718 by interacting with alphanumeric input device 714 and/or cursor control device 716.

Computer system 700 also includes an I/O device 720 for coupling computer system 700 with external entities. For example, in one embodiment, I/O device 720 is a modem for enabling wired or wireless communications between computer system 700 and an external network such as, but not limited to, the Internet. In one embodiment, I/O device 720 includes a transmitter. Computer system 700 may communicate with a network by transmitting data via I/O device 720.

Referring still to FIG. 7, various other components are depicted for computer system 700. Specifically, when present, an operating system 722, applications 724, modules 726, and data 728 are shown as typically residing in one or some combination of computer usable volatile memory 708 (e.g., RAM), computer usable non-volatile memory 710 (e.g., ROM), and data storage unit 712. In some embodiments, all or portions of various embodiments described herein are stored, for example, as an application 724 and/or module 726 in memory locations within RAM 708, computer-readable storage media within data storage unit 712, peripheral computer-readable storage media 702, and/or other tangible computer-readable storage media.

The examples set forth herein were presented in order to best explain, to describe particular applications, and to thereby enable those skilled in the art to make and use embodiments of the described examples. However, those skilled in the art will recognize that the foregoing description and examples have been presented for the purposes of illustration and example only. Many aspects of the different example embodiments that are described above can be combined into new embodiments. The description as set forth is not intended to be exhaustive or to limit the embodiments to the precise form disclosed. Rather, the specific features and acts described above are disclosed as example forms of implementing the claims.

Reference throughout this document to “one embodiment,” “certain embodiments,” “an embodiment,” “various embodiments,” “some embodiments,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics of any embodiment may be combined in any suitable manner with one or more other features, structures, or characteristics of one or more other embodiments without limitation.

In particular and in regard to the various functions performed by the above described components, devices, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter.

The aforementioned systems and components have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components. Any components described herein may also interact with one or more other components not specifically described herein.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

Thus, the embodiments and examples set forth herein were presented in order to best explain various selected embodiments of the present invention and its particular application and to thereby enable those skilled in the art to make and use embodiments of the invention. However, those skilled in the art will recognize that the foregoing description and examples have been presented for the purposes of illustration and example only. The description as set forth is not intended to be exhaustive or to limit the embodiments of the invention to the precise form disclosed.

What is claimed is:

1. A vehicle comprising:
a) a plurality of wheel-leg components, wherein the plurality of wheel-leg components can operate to provide locomotion to the vehicle; and
b) an imaging system for generating a surround view image of the vehicle.

2. The vehicle of claim 1 wherein the imaging system can generate a view image of the vehicle, the surround view image comprising a 360-degree, three-dimensional view of an environment surrounding the vehicle.

3. The vehicle of claim 1 wherein the vehicle is configured to operate autonomously based on data from the imaging system.

4. The vehicle of claim 1 wherein the imaging system comprises a plurality of cameras.

5. The vehicle of claim 1 wherein the plurality of cameras are positioned on the vehicle to provide a 360-degree view around the vehicle.

6. The vehicle of claim 1 further comprising a chassis in communication with the wheel-leg components.

7. A method comprising:
(a) providing a vehicle that comprises i) plurality of wheel-leg components coupled to the chassis, wherein the plurality of wheel-leg components can provide wheeled locomotion and walking locomotion; and ii) an imaging system for generating a view image of the vehicle;
(b) operating the vehicle.

8. The method of claim 7 wherein the imaging system can generate a view image of the vehicle, the surround view image comprising a 360-degree, three-dimensional view of an environment surrounding the vehicle.

9. The method of claim 7 wherein the imaging system comprises a plurality of cameras.

10. The method of claim 7 wherein the vehicle is operated autonomously.

11. The method of claim 7 wherein the vehicle is operated partially autonomously.

12. The method of claim 7 wherein the vehicle is operated fully autonomously.

13. The method of claim 7 wherein the vehicle further comprises a chassis in communication with the wheel-leg components.
